(19) United States
(12) Patent Application Publication
(10) Pub. No.: US 2006/0248095 A1
(43) Pub. Date: Nov. 2, 2006

(54) Efficient RAM lookups by means of compressed keys

(75) Inventor: Irene Cozzani, Mountain View, CA (US)

Correspondence Address: LAW OFFICE OF CHARLES E. KRUEGER, P.O. BOX 5607, WALNUT CREEK, CA, 94596-1607, US

(73) Assignee: CISCO TECHNOLOGY, INC. (A California Corporation)

(21) Appl. No.: 11/119,325

(22) Filed: Apr. 29, 2005

(51) Int. Cl. G06F 7/00

(52) U.S. Cl. 707/100

(57) ABSTRACT

A table lookup system utilizes an RAM-based associative table that stores compressed keys. An incoming basekey is hashed by a first set of hash functions to compute hkeys used to access a line in a corresponding subtable. A second set of hash functions compute compkeys which are stored in entries lines of corresponding subtables.

### BACKGROUND OF THE INVENTION

Table lookup is a common operation performed by many Internet switches and routers. As depicted in FIG. 1, a typical switch includes a Forwarding Engine, Line Cards, and a Switching Fabric which can be implemented as Application Specific Integrated Circuits (ASICs). The forwarding engine is a processor that has a group of tables which may include an L2 table with MAC addresses, an L3 table with IP addresses, a NetFlow table with flow identifiers, and other tables with L4-L7 information. The address lookup function examines the packet's destination address, stored in a table, and selects an output port associated with that address.

Looking up an address in a table is usually combined with a hashing operation and the performance of the lookup process depends on both the hash function and the table organization. In the switch depicted in FIG. 1, the hashing operation is performed by Linear Feedback Shift Registers (LFSRs) for high speed. Doing a lookup operation means searching for an item in the table. When the item is found (Hit), the table location will also contain other information related to the further processing for that item. For example, on L2 forwarding tables, lookup is done on MAC addresses and the related information contained in the table is the port that first received the MAC address. On L3 forwarding tables, lookup is done on IP addresses and the related information is the port where packets destined to that IP address should be sent.

When the item is not found on the table it will be inserted (Learning phase), if it is not possible to learn a new entry, then the item will be dropped (Miss). Usually hardware lookups resulting in a miss will be redirected to software, thus slowing down the performance. Tables can be implemented in various ways, including using RAM (e.g. DRAM, Synchronous DRAM (SDRAM), Reduced Latency DRAM (RLDRAM) or Ternary Content Addressable Memory (TCAM).

The hash function and the lookup process depend on whether the table is implemented in RAM, CAM (Content Addressable Memory) or TCAM (Ternary Content Addressable Memory). Usually TCAMs perform well but are expensive and have power dissipation and availability problems; on the other hand, RAMs do not perform as well but are less expensive.

FIG. 2 depicts the standard look-up technique on a TCAM-based table. TCAMs are accessed by content, the items stored in the TCAM entries are either the actual items searched for, or some compressed version of them. In the first case, the items are referred to as “full keys” and in the second case as “compressed keys”.

Compressed keys can be obtained by applying a hash function to the full keys, when the full keys are too long compared to the TCAM width. For example, in the case of NetFlow tables, the flow identifiers are very long strings (e.g. hundreds of bits), so they are compressed by a hash function in order to fit into the TCAM entries (e.g. tens of bits). Hashing is often used to convert one input string into another to be stored in a table.

When the properties of the inputs are known in advance, a perfect hash function can be designed to fill the table completely by storing different items at different locations. In practice, the search for a perfect hash is almost impossible, either because the input characteristics are unknown or because the range of variability of the input data is much larger than the available table size. Thus, the hash function cannot be a one-to-one matching, but instead the output will be shorter than the input. When the hash is explicitly designed to produce an output of a smaller size than the input, it is possible that two or more different input values are hashed to the same output value, resulting in a conflict.

When there are chances of conflicts in a TCAM table implementation, the full keys still need to be stored for comparison during lookup, so a second table, usually on RAM, is associated with a one-to-one matching to the TCAM to store the full keys corresponding to compressed keys as shown in FIG. 2. In the following, the input of the hash function is referred to as “basekey” and the output hashed key is referred to as “hkey”.

The lookup algorithm for a TCAM table is as follows. The incoming key, either the full key or the compressed key depending on the configuration, is matched against all the keys already present in the table. If the incoming key is not found, it is inserted at the first available location (TCAMs are written sequentially starting from the first location). In the case of compressed key operation the full key corresponding to the compressed key is also written in the RAM portion of the table. If the incoming key is found in the TCAM, it is a hit straight away in the full key mode, whereas in the compressed key mode a second comparison on the RAM-stored full key is necessary to resolve between a hit or a conflict. If the full key corresponding to the incoming compressed key and the RAM-stored full key match it is a hit; in case of mismatch it is a conflict due to the hash function.

The algorithm is explained in the pseudo-code below.

for each input {

evaluate hkey = hash (basekey)
lookup hkey in the table: look for hkey among all the hkeys

already written in the TCAM

if hkey is not found: INSERT hkey in the first available
empty location

and the corresponding basekey in the correspondent
location in the RAM;

if hkey is found: access the correspondent base key in
the RAM and
compare

with incoming basekey:
if basekeys match: HIT;
if basekeys mismatch: CONFLICT;

if possible use some rule to INSERT conflicting
entries
somewhere else;
else MISS

}

Some rules are necessary to deal with conflicting entries. One common method is to use a small internal CAM to redirect keys that were hashed to values already present in the TCAM. If this extra space is already full or if there is no extra space, then the conflict will be count as a miss, i.e., it is impossible to learn the new incoming entry.

The advantage of using TCAM is that it has very good lookup performances in terms of table utilization. TCAMs in full key operation assure learning a number of keys equal to the number of entries in the TCAM, hence yielding full table utilization. TCAMs in compressed key operation usually support a number of keys very close to their number of entries, apart from some misses due to conflicts produced by the hash operation.

TCAMs also have major disadvantages: they dissipate high power due to the high number of comparisons required to do the lookup; they are expensive and their cost grows dramatically with their size; and, they have scalability and availability problems since very few sizes are currently on the market.

FIG. 3 depicts a standard table implementation utilizing a RAM. Lookups on RAM-based tables can be done with linear search or other methods. However, one of the fastest and often used ways is to use the concept of a hash table, namely to precede the RAM lookup by a hashing operation, which turns the input data to be looked up, into a smaller output indicating the memory location where the input key is or should be stored.

In the lookup phase only the table location addressed by hkey is accessed, and if it is free the corresponding basekey is written into it. In case the location is already full, the incoming basekey is compared with the stored basekey, if they match it is a hit, if they do not match it is a conflict due to the hash function having hashed some different inputs to the same output. In this case some rules to deal with conflicting entries will be necessary and the use of a small internal CAM could be one option.

The algorithm is explained in the pseudo-code below.

for each input {

evaluate hkey = hash (basekey)
lookup hkey in the table: access line indexed by hkey

if line is empty: INSERT the new basekey here;
if line is full: compare incoming basekey with the
one found in the table:

if basekeys match: HIT;
if basekeys mismatch: CONFLICT;

if possible use some rule to INSERT
conflicting entries
somewhere else; else MISS

}

RAMs have the advantages of being relatively cheap, largely available and scalable, and of not dissipating too much power as compared to TCAMs. However, the performance of RAM-table lookup is worse than the TCAM counterpart in the sense that the number of entries learned is much smaller then the total number of entries in the table, usually around half, so the table is not fully utilized.

FIG. 4 depicts a technique to improve RAM-based table utilization that uses multiple-hash and multiple-way associative tables.

In this technique multiple hash functions are used to access the table. As shown in FIG. 4, the table is logically divided into H sub-tables and each of the sub-tables is accessed by only one hash. Usually tables are implemented as multiple pages in parallel, which allows each line to store multiple entries. If each line of each subtable can store N entries, then up to N conflicting keys being hashed to the same line can be handled and only the (N+1)th and following conflicts will results in misses. The structure is called an H-Nway associative table where there are H sub-tables and each subtable contains lines of N entries.

The lookup algorithm for the H-Nway associative table is as follows: For each incoming basekey, H different hashed keys are evaluated in parallel and each hashed key is used to access a line in the corresponding subtable. All the entries already present in the selected lines need to be compared with the incoming key. If the incoming key is found somewhere, then it is hit and must be only one. If the key is not found in the selected lines, it is inserted in the line with the lowest number of entries already written. In case multiple lines have the same number of entries the line in the leftmost subtable is chosen. If all the selected lines are already full, some rules to deal with conflicting entries will be used or the conflict is counted as a miss.

Using multiple hash functions has been proven to greatly improve table utilization and reduce the conflict rate, because, in case of a conflict on one hash leading to a miss, it is likely the other hashes will not have conflicts and will allow learning the new entry into a different part of the table. A discussion of the conflict rates for associative hash tables is presented in the book entitled “Using Multiple Hash Functions to Improve IP Lookups” Andrei Broder and Michael Mitzenmacher. INFOCOM 2001.

These benefits are achieved at the expense of higher complexity with respect to the basic RAM configuration (1 hash-1 way associative) because multiple hash functions have to be implemented instead of one and multiple entries have to be read at the same time. These implementations may increase bandwidth requirements or may require more parts and pins, thus increasing the cost.

With respect to the TCAMs, H-N ways associative RAM tables are much cheaper, despite the fact that usually more entries are necessary to achieve the same low level of misses.

The challenges in the field of table lookup continue to increase with demands for more and better techniques having greater flexibility and adaptability. Therefore, a need has arisen for a new system and method for efficient and low-cost table lookup techniques.

### BRIEF SUMMARY OF THE INVENTION

In one embodiment of the invention, a RAM look-up uses compressed keys along with primary keys to make efficient lookups on a RAM based table. Two parts of RAM are coupled, the usual table as it is present in a TCAM approach and an associative table, which emulates the TCAM without having the TCAM cost and power issues.

In another embodiment of the invention, an H-Nway associative table structure and multiple hash functions boost the performance of traditional RAM-based table lookups to TCAM levels. In particular the number of misses is drastically reduced and table filling efficiency is increased.

In another embodiment of the invention, the new lookup algorithm can be implemented in hardware, with fewer parts, fewer pins, and less power dissipation than traditional RAM or TCAM implementations and the implementation cost is very low, being almost 10 times cheaper than the TCAM counterpart and twice cheaper than the simple RAM option.

Other features and advantages will be apparent in view of the following detailed description and appended claims.

### BRIEF DESCRIPTION OF THE DRAWINGS

FIG. 1 is block diagram of a router architecture;

FIG. 2 is a block diagram of a TCAM-based lookup system;

FIG. 3 is a block diagram of a RAM-based lookup system;

FIG. 4 is a block diagram of H-N way associative table lookup system; and

FIG. 5 is a block diagram of an embodiment of a RAM-based associative lookup system with compressed keys.

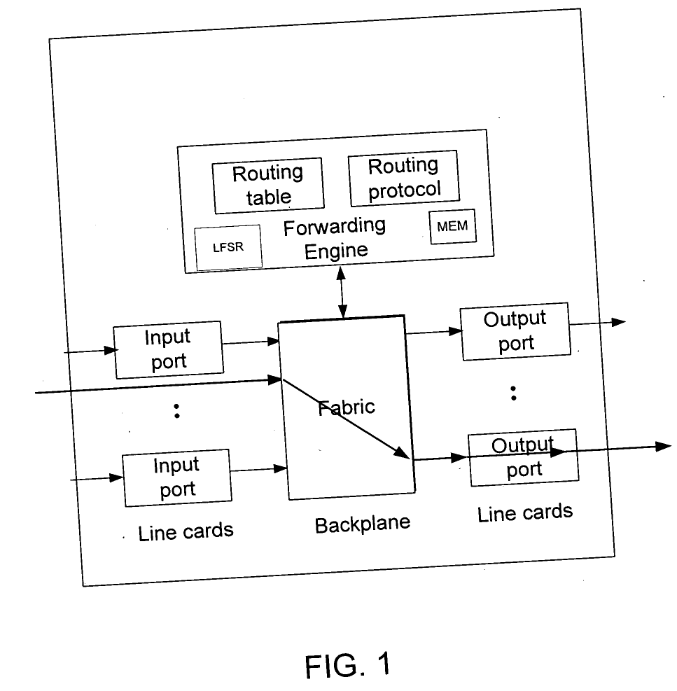

### DETAILED DESCRIPTION OF THE INVENTION

Reference will now be made in detail to various embodiments of the invention. Examples of these embodiments are illustrated in the accompanying drawings. While the invention will be described in conjunction with these embodiments, it will be understood that it is not intended to limit the invention to any embodiment. On the contrary, it is intended to cover alternatives, modifications, and equivalents as may be included within the spirit and scope of the invention as defined by the appended claims. In the following description, numerous specific details are set forth in order to provide a thorough understanding of the various embodiments. However, the present invention may be practiced without some or all of these specific details. In other instances, well known process operations have not been described in detail in order not to unnecessarily obscure the present invention.

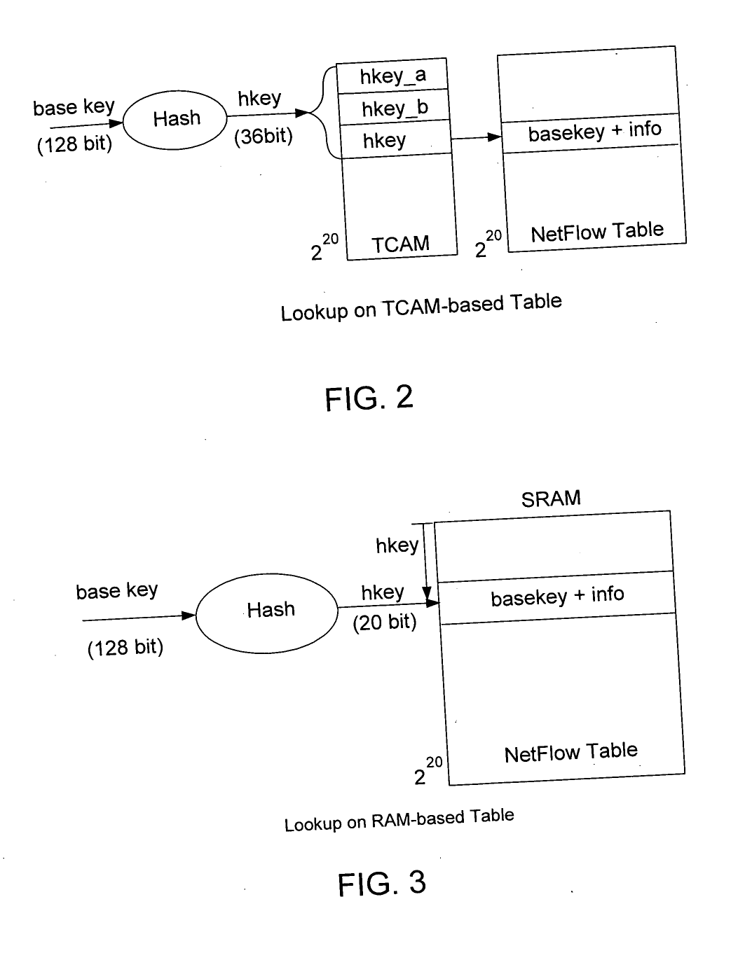

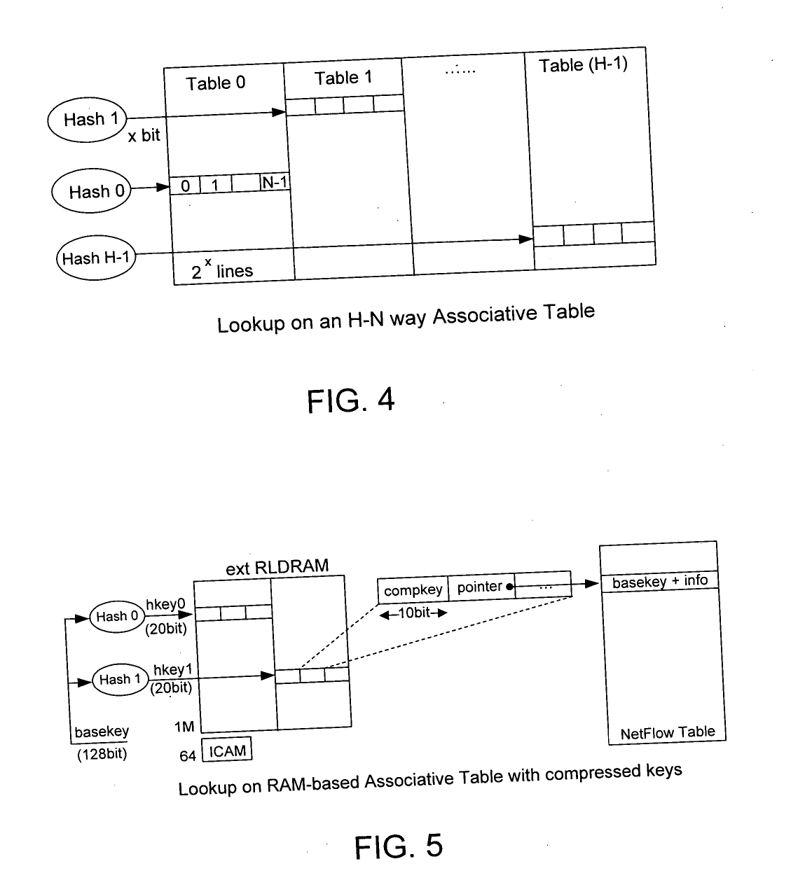

In one embodiment of the invention, the TCAM portion of the TCAM solution of FIG. 2 is replaced with an associative table implemented in RAM. The RAM is accessed with the usual hashed key and a compressed key is stored in the entry instead of the full basekey as in a basic RAM approach. FIG. 5 shows the structure of the table.

In this way, by using a fixed memory structure, a table can be built that is more associative, namely with more entries in the same line, than the one that would store the full basekey, hence improving the conflict rate. Two sets of hash functions are needed: the first hash function to hash basekey to hkey to access table lines, as in a traditional RAM approach; and, a second hash function to hash basekey to compressed keys (compkey), which are stored in the RAM entries. As described above, the hash function may be implemented utilizing LSFRs, software, or by other means.

Since compressing while hashing can lead to some conflicts, a second part of memory, still on RAM, is needed to hold the full basekey as in a traditional TCAM approach. The associative RAM table holding the compressed key is the emulation of the TCAM part and it is divided into H sub-tables, each subtable with N entries per line. Each entry holds the compressed key and a pointer to the second part of the RAM holding the basekeys.

FIG. 5 illustrates the concept for a 2-3way associative table. Each line of each subtable can hold a maximum of N entries (N=3 in FIG. 5) where all the entries in the same line have the same hkey but must hold different compkeys.

The lookup algorithm requires several changes to the one described above for traditional H-Nway associative tables. For an incoming new basekey, H different hkeys are computed and used to access a line in each of the H sub-tables. Additionally, H different compkeys are computed and compared with entries in accessed lines. The sub-tables are scanned separately, but at the same time, and all the valid entries present in the selected lines are compared with the compkey corresponding to the subtable.

If there is no match then the new entry can be learned in the line with the lowest number of valid entries. If all the selected lines are already full then the new entry can be redirected to extra memory or it is missed. If there is a match between the incoming compkey and one of those already learned (it must be only one) then a further comparison on the basekey is necessary, as was the case in the TCAM solution.

The pointer in the matched entry is used to read the corresponding basekey stored in the second RAM. If the stored basekey matches the incoming basekey it is a hit, if the two do not match it is a conflict. In one embodiment, conflicts on hkey and compkey are redirected to a backup memory as usual or they will result in misses.

The algorithm is explained in the pseudo-code below.

for each input {

```
evaluate 2 hkeys and 2 compkeys:
  [hkey0 = hash0_20 (basekey), compkey0 = hash0_10 (basekey)]
  [hkey1 = hash1_20 (basekey), compkey1 = hash1_10 (basekey)]
lookup the two sub-tables at the same time:
  access line indexed by hkey0 in subtable0 and line indexed by
  hkey1 in subtable1;
  for each line_i, (i=0,1)
```

perform comparison between compkey_i and
the compkeys which are already present (if any)

if compkey_i is not found anywhere:

INSERT it in the line with the lowest number of entries
already filled;
if all the lines are already full:

if possible use some rule to INSERT conflicting entries

somewhere else (e.g. internal small CAM);

else MISS; // CONFLICT on hkey

if compkey_i is found in line_i // could be a hit, or a conflict
on compkey

use pointer to access the SRAM table and read the
corresponding basekey
compare incoming basekey with the one found in the table
if basekeys match: HIT // some basekey, same hkey, same
compkey
if basekeys mismatch: CONFLICT on compkey,

// different basekey, same hkey, same compkey

if compkey0 was found in line0, lookup hkey1 in line1;
if compkey1 was found in line1:

if possible use some rule to INSERT conflicting entries

somewhere else (e.g. internal small CAM);

else MISS;

}

By storing compressed keys instead of full keys, the memory space can be used to hold a higher number of entries, hence the table has a higher degree of associativity than a table of the same size holding full keys. For example, for NetFlow tables, where the full basekeys are 155 bit long, a H-Nway associative table needs to be 155*H*N bits wide. If the stored keys are compressed to 10 bits and another 19 bits are used for pointers then the same associative table is only 29*H*N bit wide. The other 155 bits are stored in the associated second RAM.. Thus, the bit gain compared to standard H-Nway associative tables is about 126*H*N-155.

Accordingly, in this embodiment compressed keys are used along with the usual primary keys to make efficient lookups on a RAM based table. Two parts of RAM are coupled, the usual table as it is present in a TCAM approach and an associative table, which emulates the TCAM without having the TCAM cost and power issues.

In one embodiment the hash functions for computing hkey and compkey are primitive polynomials. A list of suitable primitive polynomials is available at the newwaveinstruments website with the extension com/resources/articles/m_sequence_linear_feedback_shift_register_lfsr.htm#Table%20of%2 0M-Sequence%20Feedback%20Taps.

Extensive simulation results on NetFlow lookups have shown the effectiveness of this new table and hashing architecture of this embodiment in reaching high performance levels as well as its hardware feasibility. In particular, in the case of a 2hash-2way associative table, the conflict rate was drastically reduced compared to the conflict rate observed in a traditional RAM solution, and almost all the flows could be learned successfully as in the TCAM solution. Moreover, the new architecture, in the particular implementation tested for NetFlow, requires fewer parts and pins than either the RAM or TCAM counterparts, dissipates less power, and is cheaper.

The invention may be implemented as program code, stored on a computer readable medium, that is executed by a digital computer. The computer readable medium may include, among other things, magnetic media, optical media, electromagnetic fields encoding digital information, and so on.

The invention has now been described with reference to the preferred embodiments. Alternatives and substitutions will now be apparent to persons of skill in the art. For example, the embodiments described above have been described as routing tables. However, the invention can be utilized in other applications where TCAMs, or other types of search techniques, are utilized such as processor caches, translation lookaside buffers, data compression applications, database accelerators, neural networks, and so on. Additionally, although hashing utilizing LFSRs are described, hashing may also be performed by a processor executing software. Accordingly, it is not intended to limit the invention except as provided by the appended claims.

What is claimed is:

1. A method for performing table lookup comprising:
providing a first RAM having H subtables, each subtable comprising a plurality of lines, with each line holding N entries where H and N are positive integers, and with each entry for holding a stored compkey and a pointer;
providing a second RAM having entries address by a pointer, for holding stored basekeys;
utilizing a first set of H hash functions, with each hash function in the first set corresponding to a unique one of the H subtables, to hash an incoming basekey into a set of H computed hkeys, with each computed hkey indexing a line in a corresponding subtable;
utilizing a second set of H hash functions, with each hash function in the second set corresponding to a unique one of the H subtables, to hash the incoming basekey into a set of H computed compkeys, with each computed compkey compressing the incoming basekey into a corresponding computed compkey;
accessing an indexed line from each subtable utilizing the computed hkey corresponding to the subtable; and
for each accessed line, comparing each stored compkey with the computed compkey corresponding to that line.

2. The method of claim 1 further comprising:
if no compkey is found in the accessed lines, inserting a computed compkey in the corresponding line having the least number of stored entries of any accessed line.

3. The method of claim 1 further comprising:
utilizing an accessed stored pointer stored in an entry holding a stored compkey that matches a computed compkey to access an accessed stored basekey from an entry in the second RAM addressed by the accessed stored pointer; and
comparing the accessed stored basekey to the incoming basekey, where there is a HIT if the accessed stored basekey matches the incoming basekey and there is a CONFLICT if the accessed stored basekey and incoming basekey mismatch.

4. A system for performing table lookup comprising:
a first RAM having H subtables, each subtable comprising a plurality of lines, with each line holding N entries where H and N are positive integers, and with each entry for holding a stored compkey and a pointer;
a second RAM having entries address by a pointer, for holding stored basekeys;
means for hashing an incoming basekey into a set of H computed hkeys, with each computed hkey corresponding to a unique subtable and indexing a line in a corresponding subtable;
means hashing the incoming basekey into a set of H computed compkeys, with each computed compkey corresponding to a unique subtable and compressing the incoming basekey into a corresponding computed compkey; and
means for accessing an indexed line from each subtable utilizing the computed hkey corresponding to the subtable; and
means for comparing, for each accessed line, each stored compkey with the computed compkey corresponding to that line.

5. A system for performing table lookup comprising:
a first RAM having H subtables, each subtable comprising a plurality of lines, with each line holding N entries where H and N are positive integers, and with each entry for holding a stored compkey and a pointer;
a second RAM having entries address by a pointer, for holding stored basekeys;
a first set of linear feedback shift registers that hash an incoming basekey into a set of H computed hkeys, with each computed hkey corresponding to a unique subtable and with each computed hkey indexing a line in a corresponding subtable;
a second set linear feedback shift registers that hash the incoming basekey into a set of H computed compkeys, with each computed compkey corresponding to a unique subtable and compressing the incoming basekey into a corresponding computed compkey; and
a processor configured to access an indexed line from each subtable utilizing the computed hkey corresponding to the subtable and, for each accessed line, that compares each stored compkey with the computed compkey corresponding to that line.

6. A computer program product for controlling a processor to for performing table lookup in a system including a first RAM having H subtables, each subtable comprising a plurality of lines, with each line holding N entries where H and N are positive integers, and with each entry for holding a stored compkey and a pointer, and a second RAM having entries address by a pointer, for holding stored basekeys, said computer program product comprising:
a computer usable medium having computer readable program code physically embodied therein, said computer program product further comprising:
computer readable program code executed by the processor hashing an incoming basekey into a set of H computed hkeys, with each computed hkey corresponding to a unique subtable and with each computed hkey indexing a line in a corresponding subtable;
computer readable program code executed by the processor for hashing the incoming basekey into a set of H computed compkeys, with each computed compkey corresponding to a unique subtable and compressing the incoming basekey into a corresponding computed compkey;
computer readable program code executed by the processor for accessing an indexed line from each subtable utilizing the computed hkey corresponding to the subtable; and
computer readable program code executed by the processor for comparing, for each accessed line, each stored compkey with the computed compkey corresponding to that line.

7. The computer program product of claim 6 further comprising:
computer readable program code executed by the processor for inserting a computed compkey in the corresponding line having the least number of stored entries of any accessed line if no compkey is found in the accessed lines.

8. The computer program product of claim 6 further comprising:
computer readable program code executed by the processor for utilizing an accessed stored pointer stored in an entry holding a stored compkey that matches a computed compkey to access an accessed stored basekey from an entry in the second RAM addressed by the accessed stored pointer; and
computer readable program code executed by the processor for comparing the accessed stored basekey to the incoming basekey, where there is a HIT if the accessed stored basekey matches the incoming basekey and there is a CONFLICT if the accessed stored basekey and incoming basekey mismatch.
